(19) United States
(12) Patent Application Publication
(10) Pub. No.: US 2020/0217361 A1
(43) Pub. Date: Jul. 9, 2020

(54) SENSOR SET FOR BEARINGS, AND BEARING ARRANGEMENT

(71) Applicant: Schaeffler Technologies AG & Co. KG, Herzogenaurach (DE)

(72) Inventor: Martin Kram, Gerolzhofen (DE)

(73) Assignee: Schaeffler Technologies AG & Co. KG, Herzogenaurach (DE)

(21) Appl. No.: 16/826,847

(22) Filed: Mar. 23, 2020

Related U.S. Application Data
(63) Continuation-in-part of application No. 15/761,216, filed on Mar. 19, 2018.

(51) Int. Cl. F16C 19/52; F16C 41/00

(52) U.S. Cl. CPC F16C 19/527; F16C 41/004; F16C 41/008

(57) ABSTRACT

Sensor sets for bearings are disclosed, e.g., for mechanical bearings. The set may include a plurality of modules, which may include one or more functional modules configured to measure bearing state variables. The functional modules may each have an electrical interface that is compatible with one another. At least one of the functional modules may be an acceleration measurement module configured to measure an acceleration which occurs on an oscillating component of the bearing. The acceleration measurement module may be configured to output an acceleration measurement signal. One or more infrastructure modules may be included for realizing communication tasks and/or for storing and/or processing pre-specified and/or recorded data. The infrastructure modules may each have an electrical interface such that they are interoperable with at least one of the functional modules. At least one of the infrastructure modules may be a signal evaluation unit configured to evaluate the acceleration measurement signal.

### CROSS-REFERENCE TO RELATED APPLICATIONS

This application is a continuation-in-part of U.S. application Ser. No. 15/761,216, which is the U.S. National Phase of PCT Appln. No. PCT/DE2016/200432 filed Sep. 15, 2016, which claims priority to DE 102015218818.3 filed Sep. 30, 2015, the entire disclosures of which are incorporated by reference herein.

### TECHNICAL FIELD

The present disclosure initially relates to a sensor set in the form of a building block on the basis of which mechanical bearings can be transformed into sensor bearings. The disclosure further relates to a bearing arrangement in the form of a sensor bearing.

### BACKGROUND

DE 101 36 438 A1 teaches a sensor arrangement in a roller bearing, in which sensor arrangement a plurality of sensor elements are integrated into bearing shells of the roller bearing. The sensor elements can be connected by means of a digital bus.

DE 10 2009 037 424 A1 discloses a bearing arrangement comprising a lubricant sensor which sends information about the state of the lubricant to a central receiving station.

DE 102 36 790 C1 presents an electrical switching device having a plurality of poles, in which electrical switching device each pole has at least one connection contact.

DE 100 64 420 B4 discloses an apparatus for detecting and evaluating physical events in a decentralized manner, in which apparatus measuring elements can be programmed by means of an internal bus system.

DE 100 54 069 A1 presents a building controller comprising a base system and comprising a logic system. The base system comprises at least one active module, while the logic system comprises at least one logic module.

DE 10 2009 021 469 A1 presents a sensor bearing unit comprising a roller bearing with a sensor housing which is arranged on a bearing ring and has an integrated sensor device for detecting bearing operating states. The sensor housing is in the form on adapter ring. The dimensions of the adapter ring are such that the radial or axial dimensions of the sensor bearing unit are at most the same as those of a ball bearing with the same supporting capability.

DE 10 2012 202 522 A1 describes a sensor bearing having a roller bearing. The roller bearing comprises an internal ring, an external ring and roller bodies arranged therebetween. The sensor bearing further contains at least one measurement pickup for measuring the forces acting on the roller bodies, and also contains a communications device which allows data interchange between the measurement pickup and a signal receiver.

The sensor bearings known at the present time are usually directed at a limited problem. In general, a specific functionality is intended to be accommodated in a specific installation space. Therefore, sensor bearings which are each optimized in respect of individual or a few aspects are developed. Therefore, for example, sensor bearings which are extremely slim are known, while other sensor bearings provide particular protection against electromagnetic influencing. The known solutions generally follow the developmental approach of a singular problem.

The prior art discloses condition monitoring sensor units which, in addition to a measuring element, also comprise a signal conditioning arrangement, a signal interface, a voltage supply and further components, and are therefore not of small construction.

### SUMMARY

An object of the present disclosure is to be able to perform condition monitoring on mechanical bearings in a more flexible and less complicated manner, proceeding from the prior art.

Said object is achieved by a sensor set and a bearing arrangement as described and shown herein.

The sensor set according to the disclosure is intended for mechanical bearings and comprises a large number of modules with which at least one mechanical bearing can be transformed into a sensor bearing. The sensor bearing is the mechanical bearing which is supplemented by a sensor system, including the components which are required for operating the sensor system, so that at least one physical variable can be measured on the mechanical bearing during operation of the mechanical bearing. For the purpose of extending the mechanical bearing to form the sensor bearing, a plurality of modules may be selected from the sensor set and arranged on the mechanical bearing. In this respect, the sensor set according to the disclosure represents a building block. The mechanical bearing may be a roller bearing.

The modules of the sensor set according to the disclosure may comprise a plurality of functional modules for measuring bearing state variables and/or for tripping and/or activating pre-specified events under pre-specified conditions. The various functional modules each have an electrical interface in respect of which they are compatible. Therefore, the various functional modules can be exchanged for one another in respect of their electrical interface. At least one of the functional modules may be formed by an acceleration measurement module which serves for measuring an acceleration which occurs on an oscillating component of the bearing. Mechanical bearings are subject to undesired periodic mechanical oscillations which occur, in particular, in the form of vibrations. These oscillations leading to the location and/or the shape of at least one component of the bearing periodically changing. The acceleration measurement module is designed to measure the acceleration which occurs in the event of this periodic change in the location and/or the shape, in order to acquire a measure for the undesired oscillation of the component of the bearing. Accordingly, the acceleration measurement module is designed to output an acceleration measurement signal. The acceleration measurement signal may be formed by raw sensor data since the acceleration measurement module may not be suitable for performing complete signal evaluation.

The modules of the sensor set according to the disclosure further comprise a plurality of infrastructure modules for realizing communication tasks and/or for storing and/or processing pre-specified and/or recorded data. The various infrastructure modules may each have an electrical interface by means of which they are interoperable with at least several of the functional modules, so that the various infrastructure modules make a contribution to ensuring functioning of the respective functional modules. At least one of the infrastructure modules may be formed by a signal evaluation unit for evaluating the acceleration measurement signal. Therefore, the signal evaluation unit may be functionally related to the acceleration measurement module. While the acceleration measurement module may provide the acceleration measurement signal in the form of raw sensor data, the signal evaluation unit serves for evaluating the raw sensor data. Therefore, these two functions may not be realized by a single module, but rather by two modules, that is to say in two different physical units. The electrical interface of the signal evaluation unit is interoperable at least with the electrical interface of the acceleration measurement module.

One particular advantage of the sensor set according to the disclosure is that it allows flexible extension of a mechanical bearing, said flexible extension making it possible to monitor the condition of the bearing.

The at least one acceleration measurement module preferably comprises an acceleration sensor element which makes it possible to directly convert the variable representing the acceleration into an electrical variable. Therefore, the acceleration sensor element is preferably designed for converting the periodic change in the geometric shape and/or in the location of the oscillating component of the bearing.

The acceleration sensor element is preferably formed by an immersion coil, by a microelectromechanical system (MEMS), or by a nanoelectromechanical system (NEMS).

The acceleration sensor element may be intended to be fixedly attached to a component of the bearing. This attachment may be inelastic.

The at least one acceleration measurement module preferably further comprises an A/D converter for converting an electrical output signal from the acceleration sensor element into the acceleration measurement signal, so that said acceleration measurement signal is available in digital form. This A/D conversion operation does not constitute evaluation of the acceleration measurement signal.

The at least one acceleration measurement module preferably further has a characteristic value forming device which serves for determining characteristic values of the output signal from the acceleration sensor element. The characteristic values form at least part of the acceleration measurement signal. Forming the characteristic values does not constitute evaluation of the acceleration measurement signal. Rather, the unit comprising the A/D converter and the characteristic value forming device can be regarded as an intelligent A/D converter.

The signal evaluation unit is preferably designed to execute algorithms for evaluating the acceleration measurement signal. To this end, the signal evaluation unit preferably comprises a computer unit.

In some embodiments of the sensor set according to the disclosure, the signal evaluation unit is also designed to evaluate signals from further different functional modules. Therefore, said signal evaluation unit may be a common signal evaluation unit. In this case, the signal evaluation unit is preferably designed for linking the acceleration measurement signal to the output signal from at least one of the further functional modules. The further functional module is formed, for example, by a temperature measurement module or by a lubricant quality measurement module, so that, for example, conclusions can be drawn about the causes of severe vibrations by virtue of the evaluation in the signal evaluation unit.

In certain embodiments of the sensor set according to the disclosure, the acceleration measurement module and all further functional modules each have an electrical interface in respect of which they are compatible, so that all functional modules can be exchanged for one another in respect of their electrical connection.

In certain embodiments of the sensor set according to the disclosure, the acceleration measurement module and at least one further functional module each have an outer shape in respect of which they are compatible. Therefore, the acceleration measurement module and the at least one further functional module can each be exchanged for one another within a bearing installation space in the bearing, which bearing installation space may be provided for this purpose. The acceleration measurement module and all further functional modules preferably each have an outer shape in respect of which they are compatible.

In certain embodiments of the sensor set according to the disclosure, the acceleration measurement module and at least one further functional module each have at least one fixing element in respect of which they are compatible. Therefore, the acceleration measurement module and the at least one further functional module can each be fixed within a bearing installation space in the bearing, which installation space may be provided for this purpose. The at least one fixing element is formed, for example, by a pin or by a screw. The acceleration measurement module and all further functional modules preferably each have at least one fixing element in respect of which they are compatible.

In certain embodiments of the sensor set according to the disclosure, the acceleration measurement module and at least one further functional module are each interoperable with the signal evaluation unit, so that they can be operated jointly and also can be exchanged for one another. The acceleration measurement module and all further functional modules are preferably each interoperable with the signal evaluation unit.

The modules of the sensor set according to the disclosure preferably further comprise a plurality of supply management modules for supplying bearing components, wherein the bearing components which are to be supplied are formed by modules from the sensor set and/or by other components of the mechanical bearing. At least several of the supply management modules are preferably different. The group of supply management modules preferably comprises at least one module for supplying electrical energy to sensor bearing components. The at least one module for supplying electrical energy is preferably designed to supply electrical energy to the acceleration measurement module and/or to the signal evaluation unit. The at least one module for supplying electrical energy is preferably formed by a voltage supply module, by a rechargeable battery module, by a battery module, by a capacitor module, by an energy management module, by an energy harvesting module, by a generator module, by a signal and energy conducting module, and/or by an energy interface module for external devices.

The group of supply management modules may comprise at least one supply management module for supplying lubricant to sensor bearing components. These sensor bearing components preferably include a grease reservoir module or oil reservoir module and also an additive module from which lubricant can be supplied to the bearing as required.

According to one embodiment, the further functional modules are formed for measuring bearing state variables, such as rotation speed, temperature, force, rotation angle and/or lubricant quality. Furthermore, the further functional modules can be designed to actuate lubricant pumps or to visually or acoustically indicate messages. The group of further functional modules preferably also includes a service module which trips corresponding activities under pre-specified conditions.

At least one further infrastructure module is preferably designed to electrically connect the modules to a connecting medium. Said connecting medium may be an interface module which adapts the electrical interface to match the respective environment, for example an interface with currents of between 4 mA and 20 mA or Ethernet. The infrastructure modules preferably contained in the sensor set further include a radio module, an RFID module, an NFC module, a memory module, a cable module, an identification module, and/or an operating hours module. By way of example, the measurement data which is recorded by the functional modules can be stored in the memory module. In addition, the memory module can also serve for storing reference data.

According to one embodiment, the connecting medium is a bus system. The connecting medium can also be a wired bus system.

At least one of the infrastructure modules is preferably designed for wireless data interchange.

The modules may be intended for a roller bearing, so that they can be at least partially integrated into a roller bearing installation space. In principle, the modules can be intended for linear bearings or for rotary bearings.

The bearing arrangement according to an embodiment of the disclosure comprises a bearing for supporting a machine element. The bearing arrangement according to the disclosure further comprises at least two of the functional modules of the sensor set according to the disclosure. In this case, one of the at least two functional modules is formed by the acceleration measurement module. The bearing arrangement according to the disclosure further comprises at least one of the infrastructure modules of the sensor set according to the disclosure. The at least one infrastructure module comprises at least the signal evaluation unit. The electrical interface of the acceleration measurement module is electrically connected to the electrical interface of the signal evaluation unit, so that the acceleration measurement signal is passed to the signal evaluation unit.

The bearing arrangement according to the disclosure preferably also exhibits those features which are specified in connection with the sensor set according to the disclosure and the preferred embodiments thereof.

The acceleration sensor element is preferably fixedly attached to a component of the bearing, wherein it is preferably connected to said component in an inelastic and rigid manner.

The bearing arrangement according to the disclosure is preferably designed for condition monitoring of the bearing by the acceleration measurement module and by the signal evaluation unit.

The modules of the bearing arrangement can be coupled to systems which are located outside the bearing, as required. For example, individual modules can be coupled to external energy supply systems and/or external devices for data processing and data evaluation.

### BRIEF DESCRIPTION OF THE DRAWINGS

Further details, advantages and developments of the disclosure can be gathered from the following description of an embodiment of the disclosure with reference to the drawing.

FIG. 1 is a schematic example of an acceleration measurement module.

FIG. 2 is an exploded view of a sensor bearing utilizing several modules including the acceleration module of FIG. 1.

### DETAILED DESCRIPTION

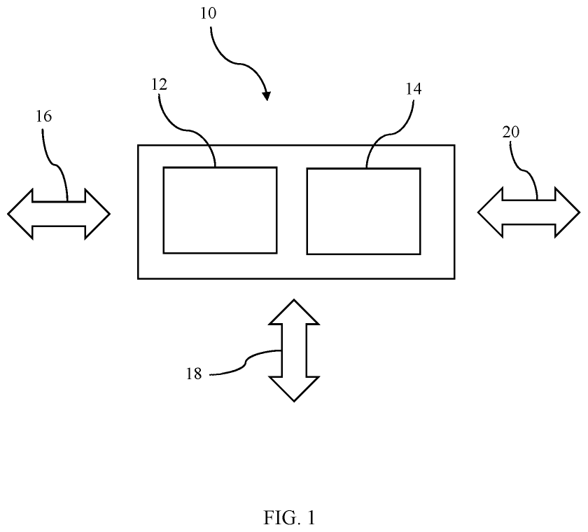

FIG. 1 shows a basic illustration of an acceleration measurement module 10 of a preferred embodiment of a sensor set according to the disclosure. The acceleration measurement module 10 comprises an acceleration sensor element 12 and an A/D converter 14 for converting an output signal from the acceleration sensor element 12. The acceleration sensor element 12 serves for measuring vibrations on a mechanical bearing (not shown). The acceleration measurement module 10 has a voltage supply and communications connection 16 by way of which it is supplied with electrical voltage and controlled. The voltage supply and communications connection 16 is compatible with corresponding connections of further modules (not shown) of the sensor set according to the disclosure, so that exchangeability is provided in this respect. The acceleration measurement module 10 has a mechanical connection 18 by way of which it can be incorporated into the mechanical bearing (not shown). The mechanical connection 18 is compatible with corresponding connections of further modules (not shown) of the sensor set according to the disclosure, so that exchangeability is provided in this respect. The acceleration measurement module 10 further has a connection for outputting an acceleration measurement signal 20 which comprises signal characteristic values in particular. The connection for outputting an acceleration measurement signal 20 is compatible with corresponding connections of further modules (not shown) of the sensor set according to the disclosure, so that exchangeability is provided in this respect too. The connection for outputting an acceleration measurement signal 20 is intended to be connected to a corresponding interface of a signal evaluation unit (not shown) of the sensor set according to the disclosure, so that the acceleration measurement signal can be evaluated in the signal evaluation unit (not shown).

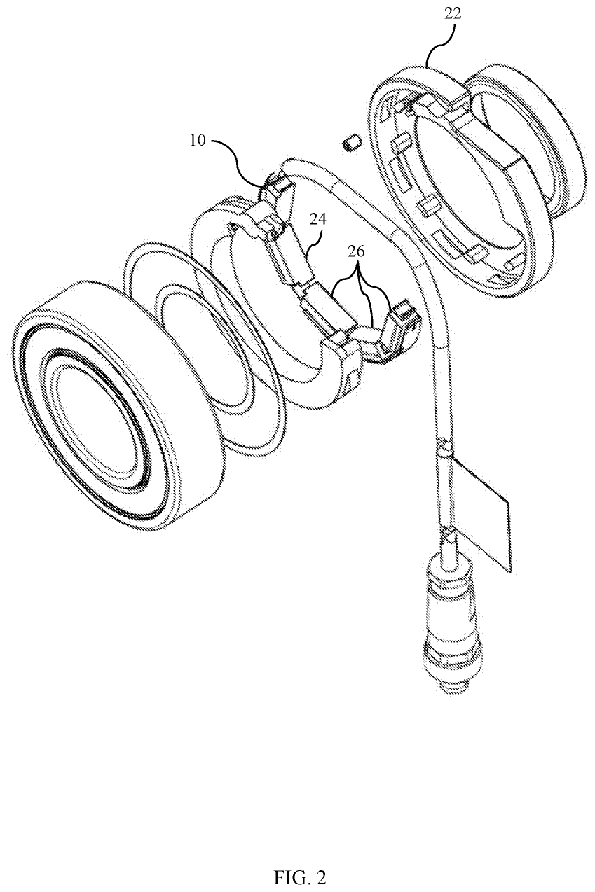

FIG. 2 shows a sensor bearing. An acceleration module 10 is attached to a fixing ring 22. The fixing ring is then attached to either the inner bearing ring or outer bearing ring. Additionally, another function module 24 is attached to the fixing ring. Module 24 senses a state variable other than acceleration, such as rotation speed, temperature, force, rotation angle and/or lubricant quality. A group of infrastructure modules 26 are also attached to the fixing ring. At least one of the infrastructure modules 26 is a signal evaluation unit for evaluating the acceleration measurement signal and output signal from the other function module 24.

Each of the modules, including the acceleration module 10, other function module 24, and infrastructure modules 26 have compatible outer shapes and electrical and mechanical interfaces. Therefore, modules can be flexibly added and/or replaced as required.

### LIST OF REFERENCE SYMBOLS

10 Acceleration measurement module
12 Acceleration sensor element
14 A/D converter
16 Voltage supply and communications connection
18 Mechanical connection
20 Connection for outputting an acceleration measurement signal
22 Fixing ring
24 Other functional module
26 Infrastructure modules

What is claimed is:

1. A sensor set for bearings, comprising:
a plurality of modules, wherein the modules comprise:
an acceleration measurement module for measuring an acceleration which occurs on an oscillating component of the bearing, which acceleration measurement module is configured to output an acceleration measurement signal;
a further functional module for measuring a bearing state variable other than acceleration, wherein the acceleration module and the further functional module each have a compatible electrical interface and a compatible shape such that the acceleration measurement module and the further functional module are interchangeable in a bearing installation space; and
a plurality of infrastructure modules for realizing communication tasks or for storing or processing pre-specified or recorded data, wherein the infrastructure modules each have an electrical interface such that they are interoperable with each of the acceleration measurement module and the further functional module, and wherein at least one of the infrastructure modules is a signal evaluation unit for evaluating the acceleration measurement signal.

2. The sensor set as claimed in claim 1, wherein the acceleration measurement module comprises an acceleration sensor element.

3. The sensor set as claimed in claim 2, wherein the acceleration measurement module further comprises an A/D converter for converting an output signal from the acceleration sensor element into the acceleration measurement signal.

4. The sensor set as claimed in claim 1, wherein the signal evaluation unit is further designed to evaluate output signals from the further functional module.

5. The sensor set as claimed in claim 4, wherein the signal evaluation unit is designed to link the acceleration measurement signal to the output signal from the further functional module.

6. The sensor set as claimed in claim 1, wherein the acceleration measurement module and the further functional module are each interoperable with the signal evaluation unit.

7. The sensor set as claimed in claim 1, further comprising a plurality of supply management modules for supplying bearing components, wherein at least one of the supply management modules is configured to supply electrical energy to the acceleration measurement module and to the signal evaluation unit.

8. The sensor set as claimed in claim 1, wherein further functional module is designed to measure rotation speed, temperature, force, rotation angle, or lubricant quality.

9. A bearing arrangement comprising:
a bearing for supporting a machine element;
a fixing ring fixed to either an inner ring or outer ring of the bearing;
an acceleration measurement module fixed to the fixing ring for measuring an acceleration which occurs on an oscillating component of the bearing, which acceleration measurement module is configured to output an acceleration measurement signal;
a further functional module fixed to the fixing ring for measuring a bearing state variable other than acceleration, wherein the acceleration module and the further functional module each have a compatible electrical interface and a compatible shape such that the acceleration measurement module and the further functional module are interchangeable in the fixing ring; and
a plurality of infrastructure modules fixed to the fixing ring for realizing communication tasks or for storing or processing pre-specified or recorded data, wherein the infrastructure modules each have an electrical interface such that they are interoperable with each of the acceleration measurement module and the further functional module, and wherein at least one of the infrastructure modules is a signal evaluation unit for evaluating the acceleration measurement signal.

10. The bearing arrangement as claimed in claim 9, wherein the acceleration measurement module comprises an acceleration sensor element.

11. The bearing arrangement as claimed in claim 10, wherein the acceleration measurement module further comprises an A/D converter for converting an output signal from the acceleration sensor element into the acceleration measurement signal.

12. The bearing arrangement as claimed in claim 9, wherein the signal evaluation unit is further designed to evaluate output signals from the further functional module.

13. The bearing arrangement as claimed in claim 12, wherein the signal evaluation unit is designed to link the acceleration measurement signal to the output signal from the further functional module.

14. The bearing arrangement as claimed in claim 9, wherein the acceleration measurement module and the further functional module are each interoperable with the signal evaluation unit.

15. The bearing arrangement as claimed in claim 9, further comprising a plurality of supply management modules for supplying bearing components, wherein at least one of the supply management modules is configured to supply electrical energy to the acceleration measurement module and to the signal evaluation unit.

16. The bearing arrangement as claimed in claim 9, wherein further functional module is designed to measure rotation speed, temperature, force, rotation angle, or lubricant quality.
